(19) United States
(12) Patent Application Publication
(10) Pub. No.: US 2007/0020972 A1
(43) Pub. Date: Jan. 25, 2007

(54) Elastomeric connectors and retention members for holding the same

(75) Inventors: Vishwa Nath Shukla, North Attleboro, MA (US); Curtis G. Knaub, Douglas, MA (US); Joseph A. Kiszka, Freehold, NJ (US); Bohdan Petro Wozniak, Warrington, PA (US); Edward J. Pupkiewicz, Lansdale, PA (US)

Correspondence Address: Robert J. Kapalka;Suite 140, 4550 New Linden Hill Road, Wilmington, DE, 19808-2952, US

(73) Assignee: Tyco Electronics Corporation

(21) Appl. No.: 11/186,504

(22) Filed: Jul. 21, 2005

(51) Int. Cl. H01R 4/58

(52) U.S. Cl. 439/86

(57) ABSTRACT

A connector assembly includes an elastomeric connector; and a flexible retention member. The retention member has a low profile body having a touchpad and an opening extending entirely through the body. The retention member also includes at least one dispensing well in communication with the opening.

### BACKGROUND OF THE INVENTION

This invention relates generally to electrical connectors and more specifically, to elastomeric connectors suitable for interconnecting circuit boards and electrical devices, and even more specifically to a keypad for holding elastomeric connectors.

An increasing complexity of electronic assemblies in smaller packages are generating a need for new connectors to interconnect electronic components. For example, crystal displays, vibratory motors, speakers and microphones are now being employed in devices of smaller and smaller size, such as cellular phone products and hand held devices. As the components become smaller and the terminals to connect the components are located closer together, known connectors are proving incapable of establishing reliable electrical connections.

The use of elastomeric connectors has become increasingly popular in some electronic devices because the connectors are readily adaptable in size and geometry to meet a large variety of applications. One type of elastomeric connector typically includes alternating layers of dielectric elastomer, such as silicon rubber, and an elastomer filled or doped with electrically conductive material such as silver particles, graphite particles, conductive fabrics, wires, etc. The dielectric elastomer layers are sandwiched between the conductive layers and are of sufficient thickness to insulate the conductive layers from one another and therefore prevent the formation of electrically conductive or leakage pathways between the conductive layers. The alternating dielectric and conductive layers provide a connector having a large number of conductive pathways in a small volume for closer contact spacing.

Elastomeric connectors are typically used for board-to-board, flex circuit-to-board, and component-to-board applications in mobile communications, portable electronic entertainment systems, hand held instrumentation and other space constrained electronic products. The elastomeric connectors are typically positioned within a dedicated cavity of the electronic product such that the elastomeric connectors have a surface-to-surface compression connection with the various components and/or boards. However, handling the elastomeric connectors as a separate component during assembly causes issues in manufacturability and ease of assembly, thus leading to increased assembly costs.

One approach that has been developed to ease assembly includes the use of a supporting boot that may be molded from an elastomeric material, such as silicone rubber, and formed around the elastomeric connector. These supporting boots typically have a thickness that is approximately equal to the thickness of the elastomeric connector to provide stability and support for the elastomeric connector. However, the supporting boots are bulky and add to the overall size of the electronic product. Other approaches use a separately provided supporting boot fabricated from an elastomeric material, such as silicone rubber, that may be assembled with the elastomeric connector prior to mounting the boot/connector assembly into the intended electronic product. However, such supporting boots require a dedicated housing or area for mounting the supporting boots within the electronic product. This dedicated housing adds to the overall size of the electronic device. Additionally, the supporting boots increase the number of components in the electronic product, thus increasing the assembly time and the assembly cost for the electronic product.

### BRIEF DESCRIPTION OF THE INVENTION

In one aspect, a connector assembly is provided including an elastomeric connector and a flexible retention member. The retention member has a low profile body having a touchpad and an opening extending entirely through the body. The retention member also includes at least one dispensing well in communication with the opening.

Optionally, the body may be substantially planar or may be substantially rectangular. In one embodiment, a retention member thickness may be substantially less than a elastomeric connector thickness. Optionally, the body may extend between first and second opposing surfaces, and the touchpad may extend from the first surface. Optionally, the dispensing well may include first and second side walls extending from and perpendicular to the first surface of the body and a bottom wall extending between the side walls and extending oblique with respect to the first surface, wherein the side and bottom walls engage the elastomeric connector such that the binding agent in the dispensing well bonds to the elastomeric connector.

In another aspect, a keypad is provided for an electronic device having an elastomeric connector therein, wherein the elastomeric connector has first and second contact interfaces separated from one another by a distance. The keypad includes a body having a thickness and extending between first and second opposing surfaces. The thickness is less than the distance between the first and second contact interfaces of the elastomeric connector, and the first surface of the body includes at least one touchpad extending therefrom. A recess within the body receives and engages the elastomeric connector therein. The keypad also includes a dispensing well within the body opening to the recess. The dispensing well is configured to receive a binding agent configured to bond to each of the body and the elastomeric connector for retaining the elastomeric connector within the recess.

In a further aspect, an electronic device is provided including a housing, a circuit board positioned within the housing, and a keypad overlaying the circuit board. The keypad includes a body having at least one touchpad extending therefrom and an opening within the body. An elastomeric connector is positioned within and directly engages the opening, and the elastomeric connector engaging the circuit board.

### BRIEF DESCRIPTION OF THE DRAWINGS

FIG. 1 is an exploded perspective view of an electronic device including an elastomeric connector and a keypad for holding the elastomeric connector in accordance with an embodiment of the present invention.

FIG. 2 is a top perspective view of the elastomeric connector shown in FIG. 1.

FIG. 3 is a top plan view of the keypad shown in FIG. 1.

FIG. 4 is a cross sectional view of a portion of the keypad taken along line 4-4 in FIG. 3.

FIG. 5 is a cross sectional view of another portion of the keypad taken along line 5-5 in FIG. 3.

FIG. 6 is an assembled perspective view of the elastomeric connector shown in FIG. 2 and the keypad shown in FIG. 3 in an assembled state.

FIG. 7 is a top perspective view of an alternative keypad receiving multiple elastomeric connectors.

### DETAILED DESCRIPTION OF THE INVENTION

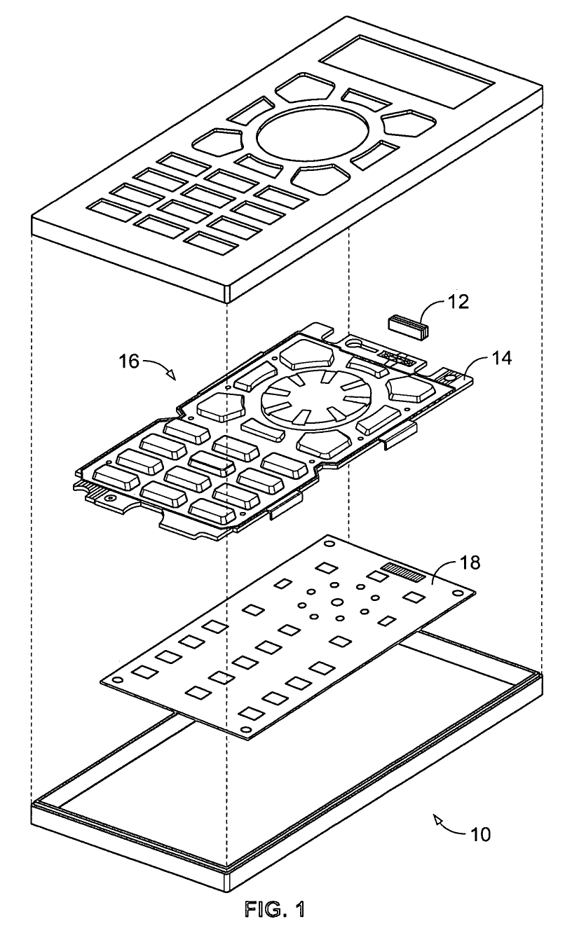

FIG. 1 is an exploded perspective view of an electronic product or device 10 including an elastomeric element or connector 12 and a retention member 14 for holding the elastomeric connector in accordance with an embodiment of the present invention. Optionally, the electronic product 10 may include multiple elastomeric connectors 12 within retention member 14. In an exemplary embodiment, the retention member 14 may be integrated into an existing component of the electronic device 10 such as, for example, a keypad 16. However, the retention member 14 may be integrated into other components within the electronic device 10 as those in the art would appreciate, and the keypad 16 is illustrated by way of example. As a result, the amount of components in the electronic device 10 may be decreased. The electronic device 10 may be utilized for an application such as, for example, mobile communications, portable electronic entertainment, hand held instrumentation or another space constrained electronic application. The electronic device 10 is provided by way of illustration and is not intended to be limited to the electronic device illustrated in FIG. 1.

The electronic device 10 includes a plurality of integrated circuit (IC) components 18 such as, for example, circuit boards, flex circuits, or other electronic components. Optionally, the IC components 18 may include LCDs, speakers, vibration motors, microphones, grounding contacts and the like. The various IC components 18 are interconnected via the elastomeric connector 12. As such, the electronic device 10 may be utilized for applications having board-to-board, flex circuit-to-board, or component-to-board connections utilizing elastomeric connectors 12. Additionally, the electronic device 10 may accommodate different connection geometries or connection patterns of the IC components 18 such as polar, co-planar, arrayed or multi-level geometries or patterns.

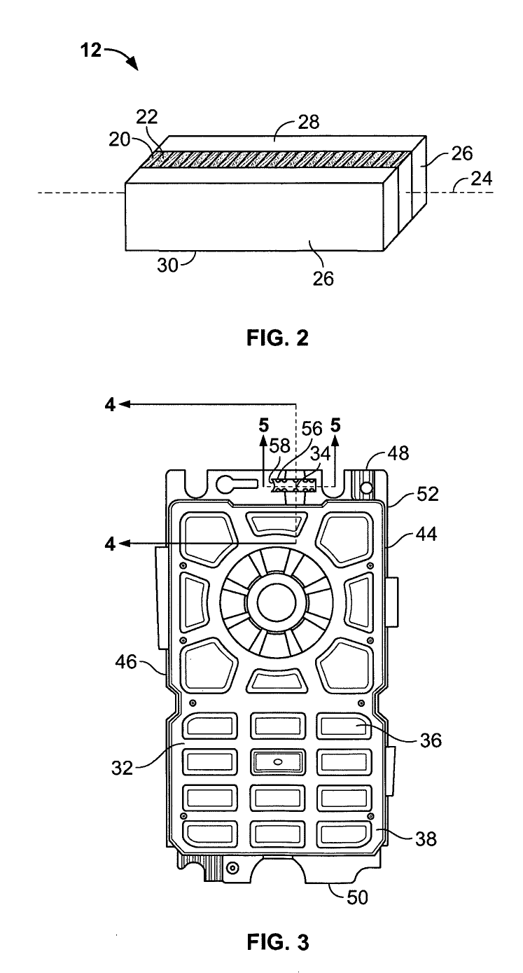

FIG. 2 is a top perspective view of the elastomeric connector 12. The elastomeric connector 12 includes alternating non-conductive layers 20 and conductive layers 22. The non-conductive layers 20 are fabricated from a dielectric or insulating material, such as silicone rubber, and the conductive layers 22 are fabricated from a material such as a known particle filled silicone elastomer. The non-conductive layers 20 and the conductive layers 22 extend substantially perpendicular to a longitudinal axis 24 of the connector 12, in a face-to-face relationship to one another in a continuous strip. The alternating non-conductive and conductive layers 20 and 22 of the elastomeric connector 12 provide a large number of conductive pathways through the elastomeric connector 12 in a relatively small volume, and the non-conductive layers 20 prevent current flow from one conductive layer 22 to another within the elastomeric connector 12.

In the illustrated embodiment, the connector 12 is of a generally rectangular shape and includes a pair of outer insulation elements 26 with the non-conductive and conductive layers 20 and 22 therebetween. The elastomeric connector 12 includes opposed top and bottom surfaces 28 and 30 extending between the upper and lower edges of the outer insulation elements 26. Each of the top and bottom surfaces 28 and 30 interface with one of the IC components 18 associated with the electronic device 10. The conductive layers 22 in the elastomeric connector 12 therefore establish a plurality of conductive paths between each of the IC components 18 interfacing with the top and bottom surfaces 28 and 30 of the connector 12.

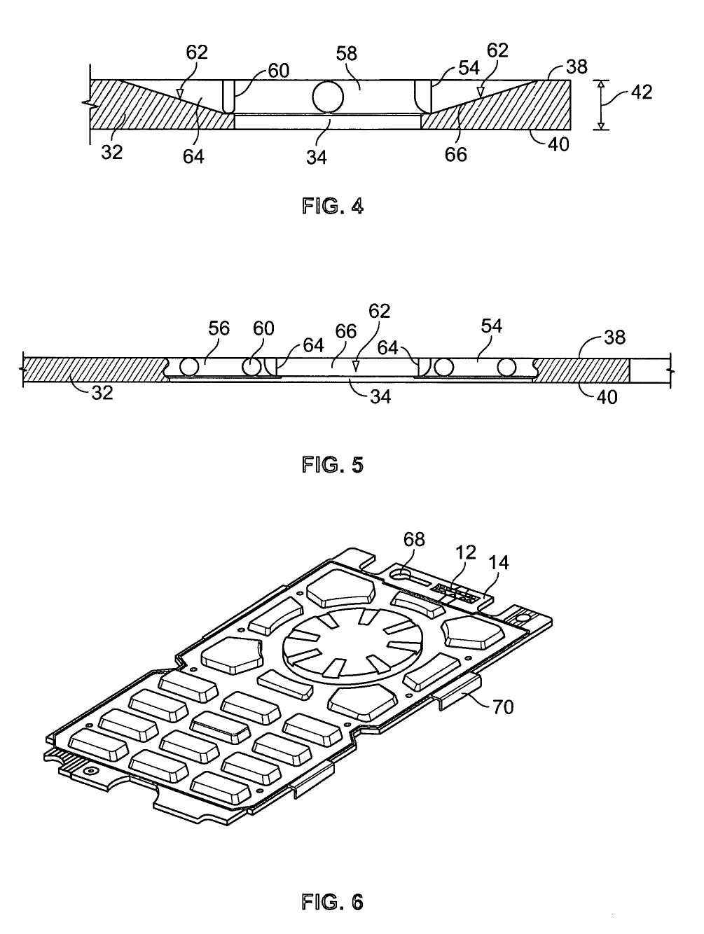

FIG. 3 is a top plan view of the keypad 16, FIG. 4 is a cross sectional view of a portion of the keypad 16 taken along line 4-4, and FIG. 5 is a cross sectional view of another portion of the keypad 16 taken along line 5-5. The keypad 16 is provided to secure the connector 12 (shown in FIG. 2) in a position or orientation to interface with the various IC components 18 when the electronic device 10 (shown in FIG. 1) is assembled. The keypad 16 includes a low profile body 32 having an opening or recess 34 for receiving the elastomeric connector 12. In the illustrated embodiment, the body 32 is generally rectangular in shape and includes a plurality of touchpads or keys 36 corresponding to the various numbers, letters, or functions associated with the electronic device 10. The touchpads 36 extend outward from the body 32. In an exemplary embodiment, the body 32 of the keypad 16 is fabricated from a flexible material such as, for example, a silicone rubber material, or the like.

The body 32 includes a first or upper surface 38 and a second or lower surface 40. The first and second surfaces 38 and 40 are generally planar and are separated from one another by a distance 42 (shown in FIG. 4). The distance 42 defines the low profile thickness of the keypad 16. As used herein, “low profile” shall refer to a thickness up to about 1.0 millimeters. In an exemplary embodiment, the distance 42 is about 0.3 millimeters to about 0.8. In a particular embodiment, the distance 42 is approximately 0.5 millimeters. The body 32 also includes first and second opposed longitudinal side walls 44 and 46, and first and second opposed lateral side walls 48 and 50. An outer edge 52 extends between each of the first and second surfaces 38 and 40 along the longitudinal and lateral side walls 44, 46, 48, and 50. The opening 34 is positioned a distance inward from the outer edge 52 of the body 32 and extends entirely between the first and second surfaces 38 and 40. As such, the opening 34 is surrounded by and defined by the body 32. In an exemplary embodiment, the opening 34 is positioned along the first lateral side wall 48. Optionally, the keypad 16 may include openings 34 along each of the side walls 44, 46, 48, and 50 of the body 32, or within other portions of the keypad 16. As such, the keypad 16 may secure multiple elastomeric connectors 12 within a single retention member.

The opening 34 is defined by a side wall 54 extending between the first and second surfaces 38 and 40. In an exemplary embodiment, and as illustrated in FIGS. 4 and 5, the opening 34 is substantially rectangular, and the side wall 54 includes opposed longitudinal portions 56 and opposed lateral portions 58. The longitudinal and lateral portions 56 and 58 extend perpendicularly with respect to the first surface 38 of the body 32, and extend perpendicularly with respect to one another. However, the opening 34 may have alternative shapes depending on the shape of the elastomeric connector 12 (shown in FIG. 2). Additionally, each of the longitudinal and lateral portions 56 and 58 include ribs or flanges 60 extending outward from the side wall 54. The ribs 60 facilitate aligning and securing the elastomeric connector 12 within the opening 34 after assembly.

The keypad 16 includes dispensing wells 62 positioned adjacent to each opening 34. The dispensing well 62 receives a binding agent selected to facilitate creating a chemical bond with each of the keypad 16 and the elastomeric connector 12. In one embodiment, the binding agent is an adhesive. Alternatively, the binding agent may be another known substance that chemically bonds the keypad 16 to the elastomeric connector 12. In the illustrated embodiment, two dispensing wells 62 are associated with the opening 34, and each dispensing well 62 extends along a longitudinal portion 56 of the side wall 54. Each dispensing well 62 opens to the first or upper surface 38 of the body 32 such that the binding agent may be delivered to the dispensing well 62. The open portion extending along and substantially co-planar with the first surface 38 is sometimes referred to hereinafter as a filling window. Each dispensing well 62 also opens to the adjacent opening 34 such that the binding agent may bond to the elastomeric connector 12 within the opening 34. The open portion extending along and substantially co-planar with the side wall 54 of the opening 34 is sometimes referred to hereinafter as a bonding window. Once assembled, the bonding window is substantially co-planar with the elastomeric connector 12.

In an exemplary embodiment, each dispensing well 62 is defined by a pair of opposed side walls 64 and a bottom wall 66. The side walls 64 of the dispensing well 62 extend inward from the filling window and are perpendicular to the first surface 38. Optionally, the side walls 64 may extend obliquely with respect to the filling window to facilitate ease of filling of the binding agent or to provide additional stability to retain the binding agent within the dispensing well 62 after the binding agent cures. The bottom wall 66 extends between the opposed side walls 64 of the dispensing well 62. In an exemplary embodiment, and as illustrated in FIG. 4, the bottom wall 66 is angled between the first surface 38 of the body 32 and the bonding window of the dispensing well 62. As such, the binding agent delivered to the dispensing well 62 flows towards the bonding window and the elastomeric connector 12. In an exemplary embodiment, the bottom wall 66 of the dispensing well 62 extends beyond the side walls 54 defining the opening 34. Optionally, the bottom wall 66 extends beyond the side walls 54 a substantially similar distance as the ribs 60 such that the bottom wall 66 of the dispensing well 62 engages the elastomeric connector 12. As such, the binding agent does not leak out of the dispensing well 62, thus reducing the amount of binding agent needed to retain the elastomeric connector 12 within the keypad 16.

FIG. 6 is a perspective view of the elastomeric connector 12 and the low profile keypad 16 in an assembled state. Specifically, the elastomeric connector 12 is positioned within and substantially fills the opening 34. In an exemplary embodiment, the outer insulation elements 26 of the elastomeric connector 12 are substantially co-planar or aligned with the bonding windows of the dispensing wells 62 to facilitate bonding with the binding agent. In one embodiment, the top and bottom surfaces 28 and 30 of the elastomeric connector 12 may extend outward from the upper and lower surfaces 38 and 40 of the keypad 16. Specifically, the thickness of the keypad 16 may be substantially less than the thickness of the elastomeric connector 12. In a particular embodiment, the thickness of the keypad 16 may be about one-half the thickness of the elastomeric connector 12.

Optionally, the elastomeric connector 12 may be friction fit within the opening 34 to supplement the chemical bond between the keypad 16 and the elastomeric connector 12. Specifically, the ribs 60 (shown in FIGS. 4 and 5) may engage the outer surfaces of the elastomeric connector 12 such that the elastomeric connector 12 is aligned within the opening 34.

The dispensing wells 62 are positioned along the elastomeric connector 12 such that the binding agent may be adhered or bonded to the outer insulation elements 26 of the elastomeric connector 12. As such, the elastomeric connector 12 may be directly coupled to the keypad 16. Once the binding agent cures, or is otherwise bonded to each of the elastomeric connector 12 and the keypad 16, the binding agent resists movement of the elastomeric connector 12 away from the body 32 during handling or assembly of the electronic product. Optionally, the dispensing well 62 may include a rib or flange (not shown) extending from the body 32 into the well portion such that the binding agent at least partially surrounds the rib or flange to provide resistance to movement of the elastomeric connector 12.

The keypad 16 may be provided with mounting holes or recesses, such as the mounting hole 68, or alignment pins or tabs, such as the mounting tab 70, for accurately positioning the assembly 10 in a final mounting position within the electronic device 10. Moreover, it will be recognized that the shape of the keypad 16 may be varied to accommodate mounting requirements in different applications.

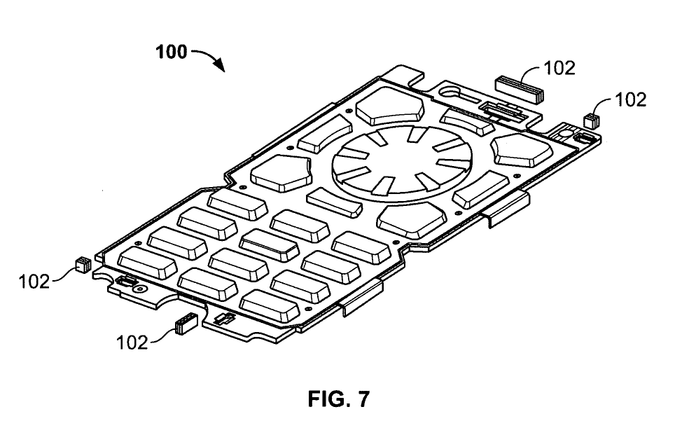

FIG. 7 is a top perspective view of an alternative keypad 100 receiving multiple elastomeric connectors 102. The keypad 100 is similar to the keypad 14 (shown in FIG. 1) and the elastomeric connectors 102 are similar to the elastomeric connector 12 (shown in FIG. 1). The difference between the keypad 100 and the keypad 14 is the keypad 100 includes multiple openings 34 for receiving the elastomeric connectors 102. Additionally, the openings 34 in the keypad 100 have different sizes and shapes as compared to the opening 34 in the keypad 14. The openings 34 have the different sizes and shapes to accommodate and retain the different sized and shaped connectors 102.

While the invention has been described in terms of various specific embodiments, those skilled in the art will recognize that the invention can be practiced with modification within the spirit and scope of the claims.

1. A connector assembly comprising:
an elastomeric connector; and
a retention member comprising a low profile body having a touchpad and an opening extending entirely through said body, said elastomeric connector received in said opening, said retention member comprising at least one dispensing well in communication with said opening, said dispensing well being configured to receive a binding agent therein to securely retain said elastomeric connector within said opening.

2. A connector assembly in accordance with claim 1, wherein said body is substantially planar.

3. A connector assembly in accordance with claim 1, wherein said body is substantially rectangular.

4. A connector assembly in accordance with claim 1, wherein said elastomeric connector has a thickness and said retention member has a thickness, said retention member thickness substantially less than said elastomeric connector thickness.

5. A connector assembly in accordance with claim 1, wherein said body extends between first and second opposing surfaces, said touchpad extends from said first surface.

6. (canceled)

7. A connector assembly in accordance with claim 1, wherein said body extends between first and second opposing surfaces, said dispensing well includes first and second side walls extending from and perpendicular to said first surface of said body and a bottom wall extending between said side walls and extending oblique with respect to said first surface, said side and bottom walls engaging said elastomeric connector such that a binding agent in said dispensing well bonds to said elastomeric connector.

8. A connector assembly in accordance with claim 1, wherein said body comprises a plurality of ribs extending into said opening to properly align said elastomeric connector within said opening.

9. A connector assembly in accordance with claim 1, further comprising multiple elastomeric connectors mounted to said retention member.

10. A keypad for an electronic device, said keypad comprising:
an elastomeric connector having first and second contact interfaces separated from one another by a distance;
a body having a thickness and extending between first and second opposing surfaces, said thickness less than the distance between the first and second contact interfaces of the elastomeric connector, said first surface of said body comprising at least one touchpad extending therefrom;
a recess within said body receiving and engaging said elastomeric connector therein; and
a dispensing well within said body and opening to said recess, said dispensing well configured to receive a binding agent configured to bond to each of said body and said elastomeric connector for retaining said elastomeric connector within said recess.

11. A keypad in accordance with claim 10, wherein said body is substantially planar.

12. A keypad in accordance with claim 10, wherein said body is substantially rectangular.

13. A keypad in accordance with claim 10, wherein said dispensing well includes first and second side walls extending from and perpendicular to said first surface of said body and a bottom wall extending between said side walls and extending oblique with respect to said first surface.

14. A keypad in accordance with claim 10, wherein said dispensing well comprises side and bottom walls defining a notched out window, said elastomeric connector abutting said window such that the binding agent in said dispensing well bonds to said elastomeric connector.

15. A keypad in accordance with claim 10, wherein said body comprises a plurality of ribs extending into said recess to properly align said elastomeric connector within said recess.

16. A keypad in accordance with claim 10, further comprising multiple elastomeric connectors mounted to said keypad.

17. An electronic device comprising:
a housing;
a circuit board positioned within said housing;
a keypad overlaying said circuit board, said keypad comprising a body having at least one touchpad extending therefrom and an opening within said body, wherein said keypad comprises a dispensing well in communication with said opening, said dispensing well configured to receive a binding agent; and
an elastomeric connector positioned within said opening and being securely retained within said opening by said binding agent, said elastomeric connector engaging said circuit board.

18. An electronic device in accordance with claim 17, wherein said dispensing well includes first and second side walls extending from and perpendicular to said first surface of said body and a bottom wall extending between said side walls and extending oblique with respect to said first surface.

19. An electronic device in accordance with claim 17, wherein said dispensing well comprises side and bottom walls defining a notched out window, said elastomeric connector abutting said window such that the binding agent in said dispensing well bonds to said elastomeric connector.

20. An electronic device in accordance with claim 17, wherein said body comprises a plurality of ribs extending into said opening to properly align said elastomeric connector within said opening.
